(19) United States
(12) Patent Application Publication
(10) Pub. No.: US 2023/0221585 A1
(43) Pub. Date: Jul. 13, 2023

(54) METHOD AND DEVICE FOR AUTOMATICALLY DETERMINING PRODUCTION PARAMETERS FOR A PAIR OF SPECTACLES

(71) Applicant: Tribe GmbH, Berlin (DE)

(72) Inventors: Kevin Metka, Berlin (DE); Pawel Jobkiewicz, Warschau (PL); Julian Hoelz, Berlin (DE)

(21) Appl. No.: 18/007,358

(22) PCT Filed: Jun. 1, 2021
(86) PCT No.: PCT/DE2021/100472

§ 371 Date: Jan. 30, 2023

(30) Foreign Application Priority Data
Jul. 31, 2020 (DE) 10 2020 004 843.9

(51) Int. Cl. G02C 13/00

(52) U.S. Cl. CPC G02C 13/005

(57) ABSTRACT

A method and device for automatically determining production parameters for a pair of spectacles. The method comprises capturing head image data for at least a part of the head of a spectacles wearer and determining a head parameterization for at least a part of the head, the head parameterization indicating head parameters for at least the part of the head, which parameters are relevant for the adjustment of a pair of spectacles. The head parameters comprise a lens grinding parameter and a spectacles support parameter. The method also comprises providing a spectacles parameterization indicating relevant spectacles parameters for adjusting the spectacles for the wearer; and performing data mapping for the head parameterization and the spectacles parameterization, in which for the adjustment of the spectacles for the spectacles wearer at least one spectacles parameter is adjusted according to an associated head parameter and/or at least one further spectacles parameter is determined.

### CROSS REFERENCE TO RELATED APPLICATIONS

This patent application is a U.S. National Phase Application under 35 U.S.C. § 371 of International Patent Application No. PCT/DE2021/100472, titled “METHOD AND DEVICE FOR AUTOMATICALLY DETERMINING PRODUCTION PARAMETERS FOR A PAIR OF SPECTACLES” filed on Jun. 1, 2021, which claims priority from German Patent Application No. 102020004843.9, filed on Jul. 31, 2020, all of which are incorporated by reference, as if expressly set forth in their respective entireties herein.

### FIELD OF THE INVENTION

The invention relates to a method and to a device for automatically determining production parameters for a pair of spectacles.

### BACKGROUND

It is known to fit spectacles on site in the presence of an optician. Without the presence of an optician, it has hitherto not been possible to reliably determine the necessary parameters for centering the spectacles lens. Likewise, no frame adjustment has been possible.

In addition, it was suggested to identify spectacles online. The spectacles wearer is asked to place a reference object, the size of which is standardized and therefore generally known, for example a credit card, on their forehead and take a photo. Since the reference object has a standardized size, the pupillary distance can be derived using simple arithmetic. However, it cannot be ensured that the reference object and the pupil of the eye are on the same frontal plane. Likewise, the orthogonal angle of the reference object to the frontal plane cannot be ensured. In practice, this results in a measurement deviation of several millimeters on average, which is unsuitable for centering the spectacles lens.

So far, the necessary parameters for centering the spectacles lens can only be determined in the presence of an optician. In particular, different devices are necessary for measuring a pupillary distance and a grinding height. In addition, the conventional measuring devices result in a high measurement variance and low accuracy. This also applies to the current mobile applications.

### SUMMARY

The object of the invention is to specify a method and a device for automatically determining production parameters for a pair of spectacles, which method in particular allows the parameters for the spectacles to be determined efficiently and with high accuracy using an online method.

The object is achieved by a method and a device for automatically determining production parameters for spectacles according to independent claims 1 and 12. Embodiments are the subject matter of the dependent claims.

According to one aspect, a method for automatically determining production parameters for a pair of spectacles is created, the following being provided in one or more processors configured for data processing: capturing head image data for at least a part of the head of a spectacles wearer; determining a head parameterization for at least the part of the head of the spectacles wearer, the head parameterization indicating head parameters for at least the part of the head of the spectacles wearer, which parameters are relevant for the adjustment of a pair of spectacles, and the head parameters comprising at least one lens grinding parameter and at least one spectacles support parameter; providing a spectacles parameterization for the spectacles, the spectacles parameterization indicating relevant spectacles parameters for adjusting the spectacles for the spectacles wearer; and performing data mapping for the head parameterization and the spectacles parameterization, in which for the adjustment of the spectacles for the spectacles wearer at least one spectacles parameter is adjusted according to an associated head parameter and/or at least one further spectacles parameter is determined.

According to a further aspect, a device for automatically determining production parameters for a pair of spectacles is created with one or more processors configured for data processing and configured for: receiving head image data for at least a part of the head of a spectacles wearer; determining a head parameterization for at least a part of the head of the spectacles wearer, the head parameterization indicating head parameters for at least the part of the head of the spectacles wearer, which parameters are relevant for the adjustment of a pair of spectacles, and the head parameters comprising at least one lens grinding parameter and at least one spectacles support parameter; providing a spectacles parameterization for the spectacles, the spectacles parameterization indicating relevant spectacles parameters for adjusting the spectacles for the spectacles wearer; and performing data mapping for the head parameterization and the spectacles parameterization, in which for the adjustment of the spectacles for the spectacles wearer at least one spectacles parameter is adjusted according to an associated head parameter and/or at least one further spectacles parameter is determined.

Furthermore, the following can be provided: capturing RGB head image data for at least a part of the head of the spectacles wearer; providing calibration data indicative of a calibration of an image recordings device used to capture RGB head image data; and determining the at least one lens grinding parameter using the RGB head image data and the calibration data by means of image data analysis, wherein a localization vector associated with the pupils is determined, which indicates an image pixel position for the pupils. With regard to the at least one lens grinding parameter, a horizontal pupillary distance can be determined, for example.

The following can also be provided: providing depth image data and determining the at least one lens grinding parameter using the RGB head image data, the depth image data, and the calibration data.

The method can also include the following: providing reference feature data that indicates a biometric reference feature for the spectacles wearer, and determining the at least one lens grinding parameter using the RGB head image data, the reference feature data, and the calibration data. The reference feature data can indicate, for example, a reference length measure, for example a diameter of the iris, as a biometric reference feature. The iris diameter has substantially the same characteristic size for a large number of people. It may be provided to first determine the at least one lens grinding parameter using the depth image data, and then to verify the result obtained by means of a determination using the reference feature data.

The at least one spectacles parameter or the at least one further spectacles parameter can include a real grinding height for spectacles designed as varifocal spectacles, in which case the following can also be provided: determining at least one fixed point of a real spectacles frame of real spectacles, which indicates a transition between a spectacles lens and the spectacles frame, wherein a localization vector associated with the at least one fixed point of the spectacles frame is determined, which indicates an image pixel position for the at least one fixed point of the spectacles frame; and vertically projecting a pupil mark indicative of the pupil onto the spectacles frame.

The at least one spectacles parameter or the at least one further spectacles parameter can include a virtual grinding height for spectacles designed as varifocal spectacles, in which case the following can also be provided: providing a 3D model of virtual spectacles, from which a spectacles parameterization for the virtual spectacles is determined; determining at least one fixed point of a spectacles frame of the virtual spectacles, which indicates a transition between a spectacles lens and the spectacles frame, wherein a localization vector associated with the at least one fixed point of the spectacles frame is determined, which indicates an image pixel position for the at least one fixed point of the spectacles frame; and vertically projecting a pupil mark indicative of the pupil onto the spectacles frame.

In the method, the 3D model of the virtual spectacles can be selected from a large number of different virtual spectacles, for which a respective 3D model is stored in a storage device. For this purpose, the respective 3D model (3D model data) is stored in advance in the storage device for the virtual spectacles. The 3D model data can be stored in a data format suitable for 3D printing (STL, OBJ, etc.).

The 3D model may include, in one example, the following spectacles model data: (i) components of a pair of spectacles—(a) front piece, bridge, cheekpieces; (b) left and right temple, temple inflection point; and (c) nose pad length and angle; and (ii) characteristics of each component: each pair of spectacles is designed slightly differently, and the components therefore have different characteristics in terms of size and shape.

When selecting the virtual spectacles, it is possible to select the one characteristic that best suits the spectacles wearer from all the characteristics for all components (“cutting away the solution space”). Three components can be considered here: (i) head parameters; (ii) spectacles parameters, and (iii) mapping logic (“cutting away the solution space”). A cutting plane method can be used. The starting point here is the entire solution space, which includes all size combinations of the spectacles components. Based on the head parameters, a size combination is then selected that fits best. “Fits best” is defined with the help of biometric and customer-relevant data, for example as follows: “Normal spectacles for a man should have a width that corresponds to the head width. A pair of sunglasses for a woman should have a width equal to the head width+10%.” This then results in the mapping logic.

Methods may also include the following: determining a 3D coordinate system; mapping the head parameterization for at least a part of the head of the spectacles wearer and the spectacles parameterization into the 3D coordinate system, and determining one or more of the following parameters in the 3D coordinate system: horizontal pupillary distance, face width at pupillary level, real grinding height, and virtual grinding height.

Based on the head parameterization, a temple length for the temples of the spectacles and a bending point for the temples can be determined for the adjustment of the spectacles.

The head parameters can include one or more lens grinding parameters from the following group: horizontal pupillary distance and head width.

The head parameters can include one or more spectacles support parameters from the following group: face width at the pupillary level, nose width, nose attachment point, ear attachment point, distance between nose and ears, and cheek contour.

The embodiments explained above in connection with the method can be provided accordingly in connection with the device.

### BRIEF DESCRIPTION OF THE DRAWINGS

Further embodiments are explained below with reference to the drawings, in which:

FIG. 1 is a schematic representation relating to a method for automatically determining production parameters for spectacles;

FIG. 2 is a schematic representation of a pair of spectacles with drawn horizontal pupillary distance and drawn real grinding height;

FIG. 3 is a schematic representation relating to the determination of a position for a pupil;

FIG. 4 is a schematic representation of a pair of spectacles with drawn real segment height;

FIG. 5 is a schematic representation of nine RGB image pixels (solid line) and four depth image pixels (dashed line) and two marked RGB image pixels (striped and checked area);

FIG. 6 is a schematic representation of four RGB image pixels (solid line) and nine depth image pixels (dashed line) and one marked depth image pixel (striped area);

FIG. 7 is a schematic representation of a canonical spectacles model with front, temple, bending point, and bending angle;

FIG. 8 is a schematic representation relating to a face width determination, and

FIG. 9 is a schematic representation relating to facial feature points.

### DETAILED DESCRIPTION OF FURTHER EMBODIMENTS

A method and a device for automatically determining production parameters for a pair of spectacles are described below using various embodiments.

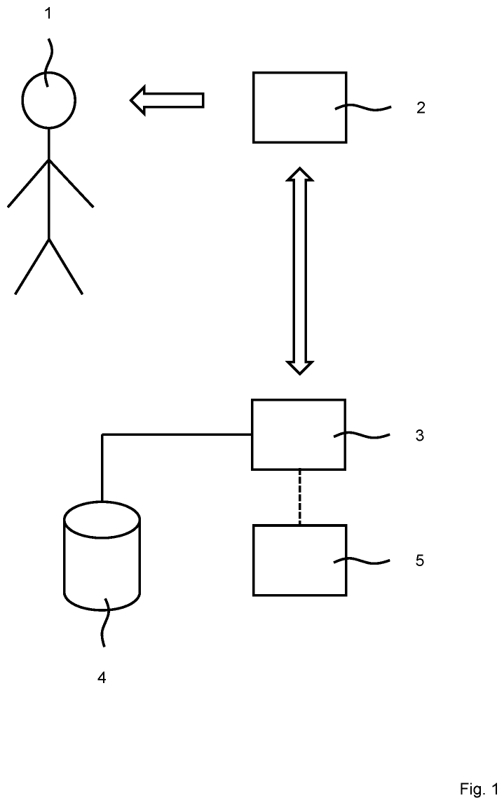

In this case, according to FIG. 1, image recordings of a head front view are recorded for a spectacles wearer 1 with the aid of a recording device 2. The recording device 2 can be formed with a mobile device such as a mobile phone, tablet, or laptop computer or a stationary end device such as a desktop computer. As is usual for such mobile devices, the recording device 2 has a camera for recording the image recordings and a display device (display) for outputting image data to the spectacles wearer 1. A user interface of the recording device 2 also has an input device for receiving inputs from the spectacles wearer 1, be it via a keyboard and/or a touch-sensitive input surface.

Commercially available mobile devices, for example mobile phones or laptop computers, are able to record a range of environmental measurement data, for example by means of one or more sensor or recording devices: CMOS camera, infrared camera, distance sensors, and point projectors.

Image recordings can be captured by means of the recording device 2, from which images digital image information can be determined: image data (RGB information); depth data (in particular distances), and calibration data (such as resolution, angle, etc.). 3D data is determined from digital image information, with the following being provided in one embodiment (cf. also further explanations below):

(i) Points of interest (POI) are detected in the image data, e.g. pupils, frames, noses, etc., up to the entire part of the head (e.g. face)

(ii) These POIs are mapped to the depth data with the help of the calibration data and biometric data (in particular for plausibility checks).

(iii) The necessary distances can be calculated from the “vectors” determined in this way. The mapping is done from “2D to 3D.” In other words, the POI is a vector (x, y), and after the mapping there is a vector (x, y, z) taking into account the depth data.

For example, POIs are mapped to the depth image data, including calibration data. The reference feature data, which indicate a biometric reference feature, can also be used for a plausibility check, for example a distribution of the horizontal pupillary distance in the population. This serves for security. For example, a warning can be generated if an unusual pupillary distance is determined, which deviates from a typical range. In this way, a corresponding action can be initiated, for example the spectacles wearer can be asked to repeat the measurement, for example to record image data/sensor data again.

If, in an alternative embodiment, no depth data is available, for example because the recording device 2 does not have a corresponding sensor, the POIs are mapped using a so-called reference method. As explained above, it is provided here that the iris (in particular the iris diameter) be used as a reference, for example. The biometric data will continue to be used for plausibility checks.

With regard to POI, only the pupil can be relevant, but also the iris contour (or the pixel position in the image). From the iris contour, the pupil (both as pixel position in the RGB image), and the diameter, the horizontal pupillary distance can be determined, in particular when no depth image data is available.

In particular for processing the image recordings and the user inputs, the recording device is connected to a data processing device 3 via a wireless or wired connection that is configured to exchange data. The data processing device 3 has one or more processors for data processing and is connected to a storage device 4.

In particular, respective spectacles data for a large number of different spectacles models are stored in the storage device 4, the spectacles data specifying characteristic data for the various spectacles models.

The data processing device is optionally connected to a production device 5 that is configured to receive parameters for spectacles to be produced and to produce them automatically, in particular a spectacles frame or parts thereof, using a 3D printer.

In the method for automatically determining production parameters for spectacles, one or more of the following parameters are determined: pupillary distance (PD), real grinding height (rSH) and virtual grinding height (vSH). With regard to an adjustment of the spectacles, provision can be made to adjust a front part, nose pads, and/or temples of the spectacles in particular during the procedure.

In particular, the following steps can be provided, which are explained in more detail below: data collection by means of image recordings; determining features and reference points and applying a projection methodology. Image data with light, color, and distance information about the recorded object (head of the spectacles wearer 1) are important for data collection. These objects are primarily a part of the face of the spectacles wearer and spectacles models. This data from the “2D world” is projected stably and precisely into a 3D world coordinate system using multi-stage projection and filter methods. The desired final measurement data for a spectacles lens centering, a custom manufacture of spectacles frames, and/or a personalized spectacles model recommendation can then be determined from position matrices.

I. Determination of Parameters

The pupillary distance (PD) is defined as the horizontal distance in millimeters (mm) between the two pupils. The center points of both pupils are used as the starting points for the measurement. The pupillary distance is necessary for centering the spectacles lens of single vision and varifocal lenses.

The real grinding height (rGH) is the vertical distance in mm of the pupil to the inner lower edge of the spectacles frame that the spectacles wearer wears during the measurement. The grinding height is necessary in order to be able to grind varifocal spectacles lenses.

The virtual grinding height (vGH) is the vertical distance in mm of the pupil to the inner lower edge of the virtual spectacles frame that the spectacles wearer sees projected onto his face via the screen of the mobile device. The grinding height is necessary in order to be able to grind varifocal spectacles lenses.

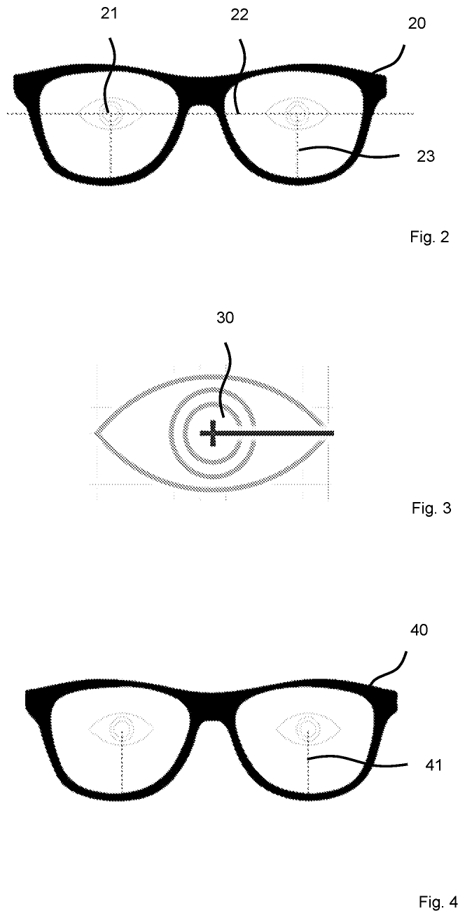

FIG. 2 shows a schematic representation of a pair of spectacles 20 with the horizontal distance 21 drawn in between the pupils 22 and the drawn real grinding height 23.

a) Features and Reference Points

According to one embodiment, the following points are defined and determined: pixel of interest in two-dimensional RGB image (POI) (pupil position, frame position of real spectacles, frame position of virtual spectacles); 3D world coordinate system; depth data in 2D depth image, and calibration data.

Pixel of interest in two-dimensional RGB image (POI): In order to determine the parameters PD, rGH, and vGH, it is necessary to determine the exact position of the pupils, for example the deepest point of the spectacles frame, the so-called box size. For this purpose, RGB images and camera calibration data (resolution of the recorded image, camera angle information) are analyzed for the corresponding mobile device (recording device 2). The pupils are determined using a pupil finder methodology (image analysis algorithms) and stored in a localization vector (POI). With the help of the calibration data, the pupils can be clearly localized as pixel information (x, y) in the RGB image.

In one embodiment, the pupil finder methodology provides a two-stage method. First, a cascaded finding of the pupil (so-called “Cascaded Convolutional Neural Networks”) is performed: (i) finding the face; (ii) finding the eye area; (iii) finding the iris; and (iv) finding the pupil. In a further step, plausibility data for comparison (biometric information) are also provided. a plausibility check can be carried out in each step of the method, for example with the help of the biometric data, for example according to the following scheme: Step (1)—Has the iris been found inside the eye area?; Step (2)—Has the pupil been found inside the iris?; . . . ; Step (n)—Is the calculated pupillary distance within a plausible range, for example 50 to 70 mm?; . . . . This supports the stability and accuracy of the method.

FIG. 3 shows a schematic representation relating to the determination of a position for a pupil 30.

For rGH, it is necessary to determine the exact position of the frame. For this purpose, a fixed point on the frame is defined as follows:
Frame: The relevant point on the frame is the transition between the lens and frame of the spectacles (and thus the “inner point of the spectacles”)
Vertical projection: Starting from the pupil found, a vertical projection onto the frame (as defined above) is carried out

Using a line finder methodology, the frame fixed points (left and right side) are determined and stored in a localization vector. This vector is congruent with the camera's calibration data, so the exact pixel position of the frame fixed points is known. A spectacles frame in an image represents a line geometry. That means an algorithm that specializes in finding lines (and thus the frame) is chosen—in particular where the line begins and where it ends. We currently use the Houghs Line Finder.

FIG. 4 shows a schematic representation of a pair of spectacles 40 with drawn real segment height 41.

The virtual spectacles are provided as a modeled 3D object to determine the virtual grinding height (vGH). Here, the exact dimensions are known. The lower central point of the bridge is defined as the anchor point on the spectacles.

3D world coordinate system: The starting point is the definition of a world coordinate system. This is a Euclidean system with an anchor point at the origin. This anchor point is defined by the lens front of the RGB camera. The orientation of the coordinate axes is defined as follows:
x-axis: Parallel to the horizontal orientation of the mobile device
y-axis: Parallel to the vertical orientation of the mobile device
z-axis: Parallel to the camera recording direction of the mobile device

Depth data in 2D depth image: Advanced mobile devices provide depth information. These greyscale images are captured synchronously with the RGB images, and the depth and RGB images can be congruently transformed together with the calibration data. The depth images contain the distance from the depth lens to the recorded object per pixel.

Calibration data: Each RGB and depth image pair contains various calibration data that further specify the capture. It is assumed that the following quantities are available or can be extracted by software: angle along x-y axis for POI; angle along y-z-axis for POI; resolution RGB image and resolution depth image.

The formalization is explained in more detail below:

1. Image Pixels of Interest in 2D RGB Image (POI)
POI=Pixels of interest=Position of relevant pixel (e.g., found pupil) in the RGB image
img_{RGB}=RGB image
img_{DEP}=depth image
p₁=Position of the left pupil in the RGB image={xₚ_{₁}, yₚ_{₁}}
p₂=Position of the right pupil in the RGB image={xₚ_{₂}, yₚ_{₂}}
f₁=Position of left frame in RGB image={x_{f}_{₁}, y_{f}_{₁}}
f₂=Position of right frame in RGB image={x_{f}_{₂}, y_{f}_{₂}}
v₁=Position of the left virtual frame in the world coordinate system={xᵥ_{₁}, yᵥ_{₁}, zᵥ_{₁}}
v₂=Position of the right virtual frame in the world coordinate system={xᵥ_{₂}, yᵥ_{₂}, zᵥ_{₂}}

2. 3 D World Coordinate System
World coordinate system=Euclidean coordinate system with three dimensions
Anchor point=Origin point=Camera lens exit point=(0,0,0)

3. Depth Image Data in 2D Depth Image

$${d}_{{p}_{1}} = Position of left pupil in depth image = \{ {x}_{{d}_{{p}_{1}}} , {y}_{{d}_{{p}_{1}}} \} \\ {d}_{{p}_{2}} = Position of right pupil in the depth image = \{ {x}_{{d}_{{p}_{2}}} , {y}_{{d}_{{p}_{2}}} \} \\ {d}_{{f}_{1}} = Position of left frame in depth image = \{ {x}_{{d}_{{f}_{1}}} , {y}_{{d}_{{f}_{1}}} \} \\ {d}_{{f}_{2}} = Position of right frame in depth image = \{ {x}_{{d}_{{f}_{2}}} , {y}_{{d}_{{f}_{2}}} \} \\ {d}_{POI} = Distance of the POI to the camera lens in mm$$

4. Calibration Data
a_{xy}_{_{POI}}=Angle along x-y axis for POI
a_{yz}_{_{POI}}=Angle along y-z axis for POI
res_{RGB}=RGB image resolution={resₓ, res_{y}}
res_{DEP}=Resolution depth image={resₓ, res_{y}}

b) Projection Methodology

In one embodiment, the projection methodology comprises four steps:
determining angles between axes in the world coordinate system
determining the distance to the POI
projecting 2D input images to the 3D world coordinate system
calculating the distance

i) Angles Between Axes in the World Coordinate System

To determine the angle between axes in the world coordinate system, the following is provided: the two angles are required for the projection into the world coordinate system. These are available in the calibration data and can be used for the projection.

ii) Determining the Distance to the POI

To determine the distance to the POI, the following is provided: a connection to the depth image must be established from the localization of the POI in the RGB image in order to determine the distance of the POI from the camera. This is done using a mapping method that takes into account the resolution of the RGB and the depth image. The resolution of the RGB and the depth image is usually different. A total of three cases can be distinguished:
Case 1: The resolution of RGB image and depth image match;
Case 2: The resolution of the RGB image is greater than the resolution of the depth image;
Case 3: The resolution of the RGB image is smaller than the resolution of the depth image.

The aim is to derive the depth information (=distance in mm) for a pixel in the RGB image that has already been found to be relevant (e.g., the pupil or the frame):

Case 1:

The coordinates of the POI in the RGB image are projected exactly onto the coordinates in the depth image. The corresponding distance information can be determined.

Case 2:

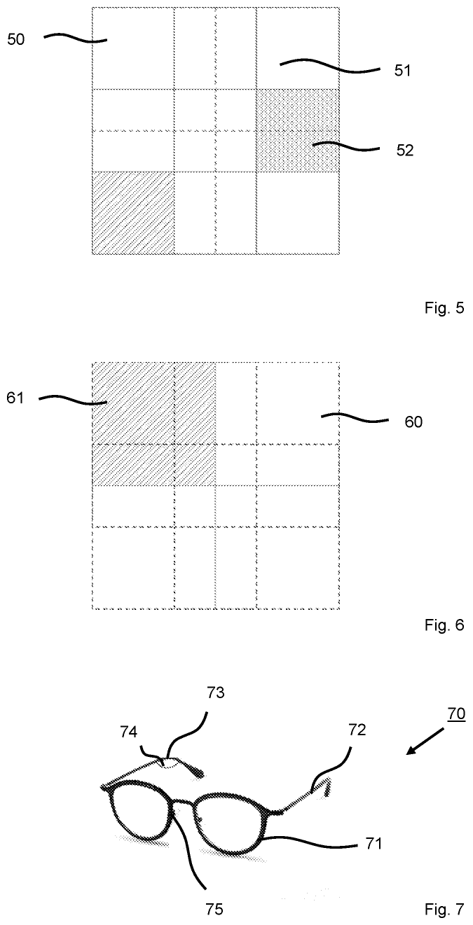

To describe the initial situation, FIG. 5 shows a schematic representation of nine RGB image pixels 50 (delimited by a solid line) and four depth image pixels 51 (delimited by a dashed line) and two marked RGB image pixels 52 (striped and checked area).

Two cases can occur:
The POI lies entirely within a depth pixel (striped area). Congruence is determined as follows: the POI is projected onto the depth image pixel with the same coordinates.
The POI is in more than one depth pixel (checkered area). Congruence is determined as follows: the POI is projected to the arithmetic average of the distances of all affected depth image pixels.

The corresponding distance information can be determined.

Case 3:

To describe the initial situation, FIG. 6 shows a schematic representation of the initial situation with four RGB image pixels 60 (delimited by a solid line) and nine depth image pixels 61 (delimited by a dashed line) and one marked depth image pixel (striped area). The POI always overlaps at least three depth image pixels (blue area). Congruence is determined as follows: the POI is projected to the arithmetic average of the distances of all overlapped depth image pixels.

iii) Projection of 2D Input Images to 3D World Coordinate System

The position in the 3D world coordinate system is calculated from the pixel distance and the two angular dimensions using a Euclidean position formula.

iv) Calculation Distance

The distance between two points in the 3D world coordinate system is calculated using a Euclidean distance formula:

PD: The pupillary distance is specified in mm and is calculated from the two pupil points in the world coordinate system.

rGH: The real grinding height is specified in mm and is calculated from a pupil point and a real frame point in the 3D world coordinate system.

vGH: The virtual grinding height is specified in mm and is calculated from a pupil point and a virtual frame point in the 3D world coordinate system.

A possible formalization is explained in more detail below.

ii) Determining the Distance to the POI

Case 1

d_{POI}=depth information from the POI in the depth image at the pixel position {xₚₒᵢ, y_{POI}}

Case 2

$${d}_{POI} = \frac{1}{N} {\sum }_{i = 1}^{N} {d}_{i} , N = number of overlapping RGB pixels$$

Case 3

$${d}_{POI} = \frac{1}{N} {\sum }_{i = 1}^{N} {d}_{i} , N = number of overlapping depth pixels$$

iii) Projection of 2D Input Images to 3D World Coordinate System

(x,y,z)=map(d_{POI},a_{xy},a_{yz})

iv) Calculation Distance

dist_{PD}=\sqrt{(xₚ_{₁}−xₚ_{₂})²+(yₚ_{₁}−yₚ_{₂})²+(zₚ_{₁}−zₚ_{₂})²}

dist_{RGHL}=\sqrt{(xₚ_{₁}−x_{f}_{₁})²+(yₚ_{₁}−y_{f}_{₁})²+(zₚ_{₁}−z_{f}_{₁})²},dist_{RSHR} analogue

dist_{RGHL}=(xₚ_{₁}−xᵥ_{₁})²+(yₚ_{₁}−yᵥ_{₁})²+(zₚ_{₁}−zᵥ_{₁})²,dist_{VSHR} analogue

One or more of the following advantages can result from the different versions:
Increase in measurement accuracy—With the proposed solution, a measurement accuracy of less than one mm can be achieved.
Minimization of measurement variance: With the proposed solution, a measurement variance of less than two millimeters can be achieved (one standard deviation).
All measurements can be carried out with just a commercially available mobile device
No real spectacles are required to determine the grinding height, a virtual fitting on the mobile device is sufficient. This allows the recommendation of suitable spectacles frames, the measurement of the necessary parameters for successful spectacles lens centering, and the frame adjustment without the presence of an optician. This allows a qualitatively equivalent online purchase of spectacles, as well as at stationary vending machines in the sense of a self-service principle. The return rate in current online spectacles sales can be significantly reduced through better recommendation and measurement, which has a positive effect on the profitability of online spectacles sellers and protects the environment by reducing the package quantities.

II. Adjusting Frames for a Custom-Made Pair of Spectacles

a) Features and Reference Points

The spectacles include in particular the front part, the left and right temples, and nose pads. A projection methodology is used to determine the optimal frame size.

The following points are determined: canonical spectacles model and modification points. Canonical in this context means the definition of the spectacles components and the sizes and shape adjustments: canonical model={all components, size adjustments, shape adjustments}. The specific spectacles model is then calculated from this finite number of combinations and retrieved from the memory. A canonical spectacles model can be defined in an embodiment using the following components: front, temples (left and right), nose pads (left and right), bending point temples (left and right), and bending angle temples (left and right).

FIG. 7 shows a schematic representation of a canonical spectacles model 70 with front part 71, temple 72, bending point 73, and bending angle 74 as well as nose pad 75.

Modification points: The frame adjustment takes place separately for each component using the following modification points:

Front: Width of the entire front part 71. The scaling is done with aspect ratio stability.

Temple: Overall length of temple 72, bending point 73, and bending angle 74

b) Projection Methodology

The projection methodology consists of two steps: front part projection method and temple projection method.

i) Front Part Projection Method

Facial measurement data are collected and applied on a discrete grid, from which the size of the front part 71 can be determined. In addition, “aesthetic principles” may be considered, for example as follows: (i) women tend to wear larger spectacles; and (ii) the eyebrows should be above the spectacles. Also, usually the pupils should not be in the lower half of the lens.

Facial measurement data: Pupillary distance and face width are collected. Pupillary distance is part of the above claim. Face width is defined as the total width of the recognizable face at the pupillary level. The face width can be captured using current face recognition methods.

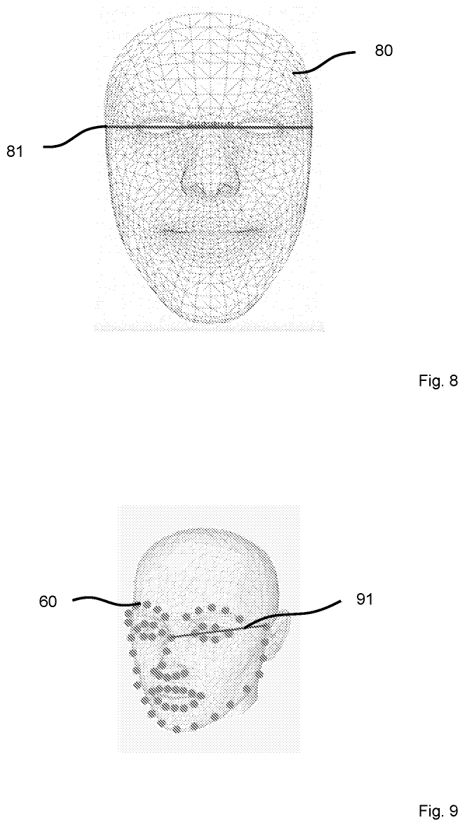

FIG. 8 is a schematic representation relating to a face width determination. A discrete grid 80 is created along the dimensions of pupillary distance and face width 81 respectively. For this purpose, static data is collected on these variables (distribution in the population) and an equidistant grid is formed from the distribution. The front part is divided into equidistant sizes and associated with each grid point tuple from pupillary distance and face width.

Projection: The size of the front part can be derived for a grid point tuple determined from pupillary distance and face width.

TABLE 1
Example table for a projection, classification S, . . . , XL
is an example and is projected onto a cardinal scale

| Pupillary distance | | | | | | |
|---|---|---|---|---|---|---|
| <45 mm | 45-55 mm | 55-65 mm | >65 mm | | | |
| S | S | M | M | <140 | mm | Face width |
| S | M | M | L | 140-150 | mm | |
| M | M | L | L | 150-160 | mm | |
| M | L | L | XL | >160 | mm | |

S, M, L classification is for illustrative purposes. Different sizes and shapes are used for each component of the spectacles, which are provided with an ID number. When determining the spectacles, an optimal size and shape is selected for each component.

A possible formalization is explained in more detail below:

Facial Measurement Data
PD=Pupillary distance in mm
FW=Face width in mm, measured at eye level
FP=Front part width in mm, measured at the widest point

Discrete Grid
R_{PD}=Pupillary distance grid={p₁, . . . , p_{N}}, N∈ [symbol]
R_{FW}=Face width Grid={g₁, . . . , g_{M}}, M∈ [symbol]
R_{FP}=Grid for front part widths={f₁, . . . , f_{L}}, L∈

[symbol]

Projection

$$( {p}_{i} , {g}_{j} ) ↦ [ \begin{matrix}{f}_{1} & … & {f}_{QVL} \\ ⋮ & ⋱ & ⋮ \\ {f}_{QVL} & … & {f}_{QVL}\end{matrix} ] , Q \leq L ; i , j ∈ ℕ$$

ii) Temple Projection Method

Facial measurement data is collected and placed on a discrete grid, from which the temple length and bending point can be determined. Here, too, additional aesthetic principles can be taken into account. For example, the temples for women's spectacles should always be a little longer, as they often put their spectacles up in their hair.

Facial measurement data: Two facial feature points are located: nose attachment point and ear attachment point. The nose attachment point and ear attachment point serve as references for the contact points of the nose pads and temples. These points can be captured using face recognition methods.

FIG. 9 shows a schematic representation relating to facial feature points 90. In addition, the face width is determined so that a connecting line 91 of the two facial feature points determined can be shifted in such a way that it corresponds to the natural temple position (laterally parallel to the head—from the ear attachment point to the temple). Together with the depth data from the identified facial feature points, the length of the temple to the bending point can then be determined.

Discrete grid: A discrete grid is created along the dimension “Length of the temple to the bending point.” For this purpose, static data is collected on these variables, i.e., the average distribution in the population is used and an equidistant grid is formed from this distribution. The temples are divided into equidistant lengths and associated with each grid point from “Length of the temple to the bending point.”

Projection: The length of the temple and the bending point can be derived for a determined grid point from “Length of the temple to the bending point.”

TABLE 2
Example table for a projection, classification S, . . . , XL
is an example and is projected onto a cardinal scale
Length of the temple to the bending point

| <100 mm | 100-110 mm | 110-120 mm | >120 mm |
|---|---|---|---|
| S | M | L | XL |

A possible formalization is explained in more detail below:

Facial Measurement Data
NP=Nose attachment point in the world coordinate system
EP=Ear attachment point in the world coordinate system
FW=Face width in mm, measured at eye level

$$L = Distance NP - EP in the world coordinate \\ system ( calculation analogous to the previous chapter ) \\ NED = Projected nose - to - ear distance = \sqrt{L - {( \frac{FW}{2} )}^{2}}$$

Discrete Grid
R_{NED}=Grid for projected nose-to-ear distances={n₁, . . . , n_{N}}, N∈ [symbol]
R_{TL}=Grid for temple lengths up to the bending point={b₁, . . . , b_{L}}, L∈

[symbol]

Projection

nᵢ [symbol] (b₁ . . . b_{QVL}), Q≤L; i∈

[symbol]

One or more of the following advantages can result from the different versions. It is possible to adapt a spectacles frame to an individual head shape. All that is needed is a standard mobile device. An automated method has been created (scalable). The delivery time can be shortened by combining it with 3D printing technology. In addition, wearing comfort can be significantly increased with custom-made spectacles. It also eliminates the need for subsequent adjustment of the spectacles frame to the wearer's head, for example in the nose or ear region, which in turn eliminates the need for the presence of an optician and allows for online or over-the-counter sale of spectacles.

III. Determining a Spectacles Recommendation

In order to determine a recommendation, all relevant input data is captured. This includes facial analysis data, preferences about existing objects (spectacles), and visual data (images of spectacles).

a) Features and Reference Points

The following points are determined: face width, portfolio, and preferences of the spectacles wearer.

Face width: The face shape is a relevant aspect when it comes to the fashionable fit of spectacles. The face width is used for this purpose and is defined as the recognizable width of the face in mm at the level of the eyes.

Portfolio: The spectacles portfolio includes all relevant spectacles that are available for deriving the recommendation. Each item of this portfolio contains two pieces of information: an RGB image of the spectacles and a classification according to descriptive features (shape, color, style, etc.).

Preferences: Preferences are a binary vector that assigns the preference (preferred, not preferred) to each image.

A possible formalization is explained in more detail below:

1. Face Width
FW=face width in mm, measured at the pupillary level

2. Portfolio

$$N = number of spectacles in the total portfolio \\ {b}_{i} ( j ) = spectacles with index i , i ∈ \{ 1 , … , N \} , \\ contains RGB image and classification j , j = 1 , … , P \\ {PF}_{total} = \{ {b}_{1} , … , {b}_{N} \} = total portfolio$$

3. Preferences
M=number of spectacles with preference, M≤N
pⱼ=preference for spectacles with index j, j∈{1, . . . , M}, pⱼ∈{0,1}

b) Projection Methodology

The projection methodology consists of three steps: face projection method, image projection method, and image preference method.

i) Face Projection Method

Facial measurement data is collected and placed on a discrete grid, from which the recommended spectacles can be determined.

Facial measurement data: The face width is collected. The face width is defined as the total width of the recognizable face at the pupillary level. The face width can be captured using current face recognition methods.

Discrete grid: A discrete grid is created along each face width dimension. For this purpose, static data is collected on these variables (distribution in the population) and an equidistant grid is formed from the distribution. The spectacles portfolio is divided into equidistant sizes and associated with each grid point based on the face width.

Projection: The recommended spectacles can be derived for a grid point determined from the face width.

ii) Image Projection Method

For a fixed RGB image with recognizable spectacles (input image), a trained neural network is used to perform feature extraction. As a result, a suitable similarity metric is used, which compares the input image with every image in the portfolio and sorts it according to confidence.

The similarity metric is provided with a confidence level from which applies “these spectacles are similar to the input image,” so that a recommendation sub-portfolio can be derived.

iii) Image Preference Method

For a set of fixed RGB images with recognizable spectacles (input images from the recording device 2), a trained neural network is used to perform feature extraction. As a result, a similarity metric is used, which compares the input images with each image for existing spectacles and sorts them according to confidence. A preference vector can be used as an additional input parameter, which indicates one or more preferences determined from the input images. Such a preference may concern qualitative factors for the user, for example one or more factors from the following group: sunglasses or regular spectacles, color, material, brand, and the like.

The similarity metric is provided with a confidence level from which applies “these spectacles are similar to the input image and preferred,” so that a recommendation sub-portfolio can be derived.

A possible formalization is explained in more detail below:

1. Face Projection Method

$${R}_{FW} = Grid for face widths = \{ {g}_{1} , … , {g}_{N} \} , N ∈ ℕ \\ {g}_{i} ↦ [ \begin{matrix}{b}_{1} ( 1 ) & … & {b}_{1} ( P ) \\ ⋮ & ⋱ & ⋮ \\ {b}_{N} ( 1 ) & … & {b}_{N} ( P )\end{matrix} ] , i ∈ ℕ$$

2. Image Projection Method
imgᵢₙₚᵤₜ=Input image with recognizable spectacles
NN(imgᵢₙₚᵤₜ)=Trained neural network with input image
α={α₍₁₎, . . . , α_{(N)}}=NN(imgᵢₙₚᵤₜ)=Sorted confidence vector

3. Image Preference Method

imgᵢₙₚᵤₜ={imgᵢₙₚᵤₜ_{₁}, . . . , imgᵢₙₚᵤₜ_{_{M}}}=M Input images with recognizable spectacles

p={p₁, . . . , p_{M}}=Preference vector for all images j=1, . . . , M

NN(imgᵢₙₚᵤₜ, p)=Trained neural network with input images 1, . . . , M and preference vector

α={α₍₁₎, . . . , α_{(N)}}=NN(imgᵢₙₚᵤₜ, p)=Sorted confidence vector

One or more of the following advantages can result from the different versions: all in one mobile device; consideration of all relevant visual data and consideration of preferences. So far, only self-selection was possible online, but this was insufficient, since spectacles wearers do not know how their head size compares to the rest of the spectacles wearer population. In concrete terms, this means that nobody says of themselves: “I have a statistically significantly large head.” Recommendations based purely on preference are inadequate when it comes to spectacles. Head and face shape recognition can be automated without the presence of an optician, for example online or at a self-service machine, and also combined with deep learning-based preference recognition.

The features disclosed in the above description, the claims, and the drawings may be of relevance, both individually and also in any combination, for realizing the different embodiments.

1. A method for automatically determining production parameters for a pair of spectacles, the following being provided in one or more processors configured for data processing, and the method comprising:
capturing head image data for at least a part of the head of a spectacles wearer;
determining a head parameterization for at least the part of the head of the spectacles wearer,
the head parameterization indicating head parameters for at least the part of the head of the spectacles wearer, which parameters are relevant for the adjustment of a pair of spectacles, and
the head parameters comprising at least one lens grinding parameter and at least one spectacles support parameter;
providing a spectacles parameterization for the spectacles, the spectacles parameterization indicating relevant spectacles parameters for adjusting the spectacles for the spectacles wearer; and
performing data mapping for the head parameterization and the spectacles parameterization, in which for the adjustment of the spectacles for the spectacles wearer at least one of the following is provided:
at least one spectacles parameter is adjusted according to an associated head parameter, and
at least one further spectacles parameter is determined.

2. The method according to claim 1, further comprising:
capturing RGB head image data for at least a part of the head of the spectacles wearer;
providing calibration data indicative of a calibration of an image recording device used to capture the RGB head image data; and
determining the at least one lens grinding parameter using the RGB head image data and the calibration data by means of image data analysis, wherein a localization vector associated with the pupils is determined, which indicates an image pixel position for the pupils.

3. The method according to claim 2, further comprising:
providing depth image data; and
determining the at least one lens grinding parameter using the RGB head image data, the depth image data, and the calibration data.

4. The method according to claim 2, further comprising:
providing reference feature data that indicates a biometric reference feature for the spectacles wearer; and
determining the at least one lens grinding parameter using the RGB head image data, the reference feature data, and the calibration data.

5. The method according to claim 1, characterized in that the at least one spectacles parameter or the at least one further spectacles parameter includes a real grinding height for spectacles designed as varifocal spectacles, and further comprising:
determining at least one fixed point of a real spectacles frame of real spectacles, which indicates a transition between a spectacles lens and the spectacles frame, wherein a localization vector associated with the at least one fixed point of the spectacles frame is determined, which indicates an image pixel position for the at least one fixed point of the spectacles frame; and
vertically projecting a pupil mark indicative of the pupil onto the spectacles frame.

6. The method according to claim 1, characterized in that the at least one spectacles parameter or the at least one further spectacles parameter includes a virtual grinding height for spectacles designed as varifocal spectacles, and further comprising:
providing a 3D model of virtual spectacles, from which a spectacles parameterization for the virtual spectacles is determined;
determining at least one fixed point of a spectacles frame of the virtual spectacles, which indicates a transition between a spectacles lens and the spectacles frame, wherein a localization vector associated with the at least one fixed point of the spectacles frame is determined, which indicates an image pixel position for the at least one fixed point of the spectacles frame; and
vertically projecting a pupil mark indicative of the pupil onto the spectacles frame.

7. The method according to claim 6, characterized in that the 3D model of the virtual spectacles is selected from a large number of different virtual spectacles, for which a respective 3D model is stored in a storage device.

8. The method according to claim 1, further comprising:
determining a 3D coordinate system;
mapping the head parameterization for at least a part of the head of the spectacles wearer and the spectacles parameterization into the 3D coordinate system, and
determining one or more of the following parameters in the 3D coordinate system: horizontal pupillary distance, face width at pupillary level, real grinding height, and virtual grinding height.

9. The method according to claim 1, characterized in that, based on the head parameterization, a temple length for the temples of the spectacles and a bending point for the temples are determined for the adjustment of the spectacles.

10. The method according to claim 1, characterized in that the head parameters include one or more lens grinding parameters from the following group: horizontal pupillary distance and head width.

11. The method according to claim 1, characterized in that the head parameters include one or more spectacles support parameters from the following group: face width at the pupillary level, nose width, nose attachment point, ear attachment point, distance between nose and ears, and cheek contour.

12. A device for automatically determining production parameters for a pair of spectacles, comprising one or more processors configured for data processing and configured for:
receiving head image data for at least a part of the head of a spectacles wearer;
determining a head parameterization for at least a part of the head of the spectacles wearer,
the head parameterization indicating head parameters for at least the part of the head of the spectacles wearer, which parameters are relevant for the adjustment of a pair of spectacles, and
the head parameters comprising at least one lens grinding parameter and at least one spectacles support parameter;
providing a spectacles parameterization for the spectacles, the spectacles parameterization indicating relevant spectacles parameters for adjusting the spectacles for the spectacles wearer; and
performing data mapping for the head parameterization and the spectacles parameterization, in which for the adjustment of the spectacles for the spectacles wearer at least one of the following is provided:
at least one spectacles parameter is adjusted according to an associated head parameter, and
at least one further spectacles parameter is determined.
